(19) United States
(12) Patent Application Publication
(10) Pub. No.: US 2026/0214070 A1
(43) Pub. Date: Jul. 23, 2026

(54) INFORMATION HANDLING SYSTEM WITH SECURE CONTENT

(71) Applicant: DELL PRODUCTS L.P., Round Rock, TX (US)

(72) Inventors: Shun-Tang Hsu, Taipei (TW); Yung-Sheng Lin, Bade District (TW); Daniel L. Hamlin, Round Rock, TX (US)

(21) Appl. No.: 19/033,631

(22) Filed: Jan. 22, 2025

(51) Int. Cl. H04L 51/48

(52) U.S. Cl. CPC H04L 51/48

(57) ABSTRACT

An information handling system may include a computer readable medium having an artificial intelligence (AI) email model and a processor operably coupled to the computer readable medium to access the (AI) email model. The processor receives user generated content including previous emails, recipients, company rules, non-disclosure agreements, joint venture agreements, supplier agreements, other business agreements, or a combination thereof. The processes trains the AI email model using the user generated content. Further, the processor executes the AI email model when an email with a list email recipients is created prior to transmitting the email.

### FIELD OF THE DISCLOSURE

The present disclosure generally relates to information handling systems, and more particularly relates to an information handling system having an electronic mail function executing therein.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include a computer readable medium having an artificial intelligence (AI) electronic mail (email) model and a processor operably coupled to the computer readable medium to access the (AI) email model. The processor may receive user generated content including previous emails, recipients, company rules, non-disclosure agreements, joint venture agreements, supplier agreements, other business agreements, or a combination thereof. The processor may train the AI email model using the user generated content. Further, the processor may execute the AI email model when an email with a list email recipients is created prior to transmitting the email.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to an embodiment of the present disclosure;

FIG. 2 is a first portion of a flow diagram of a method for securing sensitive information during email communication using artificial intelligence in an information handling system according to an embodiment of the present disclosure;

FIG. 3 is a second portion of a flow diagram of a method for securing sensitive information during email communication using artificial intelligence in an information handling system according to an embodiment of the present disclosure; and

FIG. 4 is a block diagram of another information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

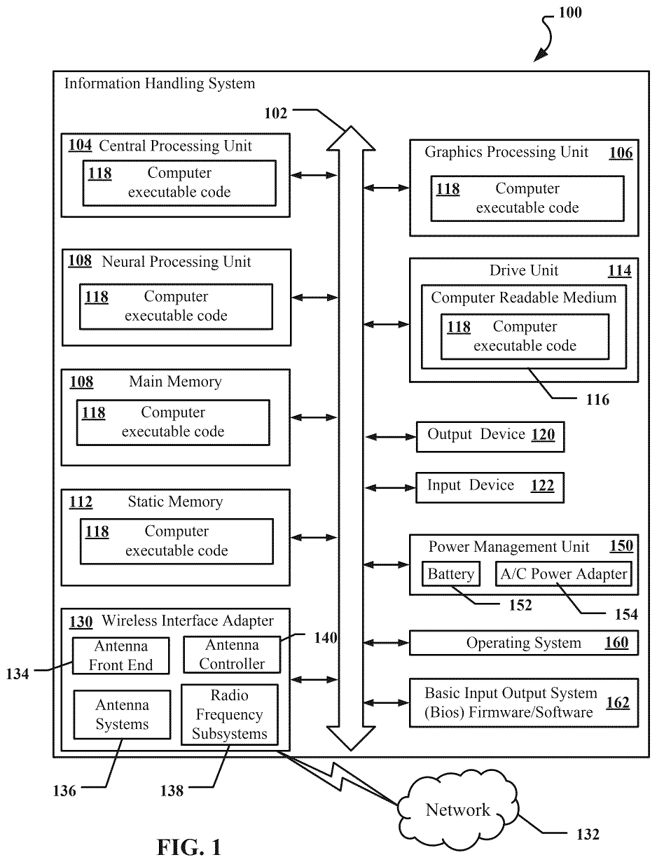

FIG. 1 illustrates an information handling system 100 having various components disposed therein. For purposes of this disclosure, the information handling system 100 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 100 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 100 may operate in the capacity of a server or as a client computer in a server-client network environment, or as a peer computer system in a peer-to-peer (or distributed) network environment. In a particular embodiment, the information handling system 100 can be implemented using electronic information handling systems that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

In general, the information handling system 100 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 100 can include one or more storage devices, one or more communications ports for communicating with external devices, as well as, various input and output (I/O) devices, such as a keyboard, a mouse, a video/graphic display, or any combination thereof. The information handling system 100 can also include one or more buses operable to transmit communications between the various hardware components. Portions of an information handling system 100 may themselves be considered information handling systems 100. The information handling system 100 can include devices or modules that embody one or more of the devices or execute instructions for the one or more systems and modules described herein, and operates to perform one or more of the methods described herein.

As illustrated in FIG. 1, in particular, the information handling system 100 can include one or more buses 102 operable to transmit communications between the various hardware components such as any combination of various input and output (I/O) devices described herein. The information handling system 100 can include one or more processors operably coupled to the bus 102. For example, the information handling system 100 can include a central processing unit (CPU) 104, a graphics processing unit (GPU) 106, a neural processing unit (NPU) 108, or any combination thereof. The CPU 104, the GPU 106, and the NPU 108 may include control logic and may individually, or collectively, operate to execute code that is either firmware or software code. Moreover, the information handling system 100 can include one or more memory devices such as a main memory 110, a static memory 112, and a drive unit 114 having a computer readable medium 116 disposed therein. The drive unit 114 can include a hard drive unit, a solid state drive unit, or a combination thereof. Further, the various memory devices 110, 112, 114, 116 may include volatile memory (e.g., random-access memory, etc.), nonvolatile memory (read-only memory, flash memory etc.) or any combination thereof).

The information handling system 100 includes computer executable code 118 that may reside on, or be executed by, the CPU 104, the GPU 106, the NPU 108, the main memory 110, the static memory 112, the computer readable medium 116 of the drive unit 114, or any combination thereof. The computer executable code 118 can include instructions (e.g., software algorithms), parameters, and profiles. The computer executable code 118 that may operate on servers or systems, remote data centers, or on-box in individual client information handling systems according to various embodiments herein. In some embodiments, it is understood any or all portions of the computer executable code 118 may operate on, or be executed by, the CPU 104, the GPU 106, the NPU 108, the main memory 110, the static memory 112, the computer readable medium 116 of the drive unit 114, or any combination thereof. In some embodiments, it is understood any or all portions of computer executable code 118 may operate on a plurality of information handling systems 100.

As shown, the information handling system 100 may further include an output device 120, e.g., a video display output. In an embodiment, the output device 120 may include a liquid crystal display (LCD), an organic light emitting diode (OLED), a flat panel display, a solid-state display, a curved panel display, a flexible panel display, or a combination thereof. Further, the output device 120 may include one or more sound output devices, e.g., speakers. As further illustrated, the information handling system 100 may include an input device 122 that may include an alpha numeric input device, such as a keyboard, and/or a cursor control device, such as a mouse, touchpad, or gesture or touch screen input device.

The information handling system 100 may also include a network interface device, shown as a wireless interface adapter 130, that can provide connectivity to a network 132, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 100 to a network. In a specific embodiment, the network 154 may include macro-cellular connections via one or more base stations, one or more wireless access points (e.g., Wi-Fi or WiGig), one or more licensed or unlicensed WWAN small cell base stations, or a combination thereof. Further, network connectivity may be a wired or wireless connection.

As depicted, the wireless interface adapter 130 may include an antenna front end 134, one or more antenna systems 136, one or more radio frequency subsystems 138, and an antenna controller 140. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 134 may communicate with one or more wireless technology protocols. The radio frequency subsystem 134 may contain individual subscriber identity module (SIM) profiles for each technology service provider and their available protocols for any operating subscriber-based radio access technologies such as cellular LTE communications.

In some embodiments of the present disclosure, the wireless interface adapter 130 may operate two or more wireless links. In a further embodiment, the wireless interface adapter 130 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 130 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1(NRFR1 ), NFRF2, bands, and other known bands. Each of these frequencies used to communicate over the network 154 may be based on the radio access network (RAN) standards that implement, for example, eNodeB or gNodeB hardware connected to mobile phone networks (e.g., cellular networks) used to communicate with the information handling system 100. In the example embodiment, mobile device 100 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 100 may operate on a licensed WWAN wireless radio with authorization for subscriber access to a wireless service provider on a carrier licensed frequency band.

The wireless interface adapter 130 can represent an add-in card, wireless network interface module that is integrated with a main board of the information handling system or integrated with another wireless network interface capability, or any combination thereof. In an embodiment the wireless interface adapter 130 may include one or more radio frequency subsystems 130 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 130 include wireless controllers to manage authentication, connectivity, communications, power levels for transmission, buffering, error correction, baseband processing, and other functions of the wireless interface adapter 130.

The information handling system 100 may further include a power management unit (PMU) 150 (a.k.a. a power supply unit (PSU)). The PMU 150 may manage the power provided to the components of the information handling system 100, e.g., the CPU 104, the GPU 106, the NPU 108, the main memory 110, the static memory 112, the drive unit 114, the output device 120, the input device 122, the wireless interface adapter 130, any combination thereof, and any other components that may require power when a power button on the information handling system 100 is actuated by a user. In an embodiment, the PMU 150 may monitor power levels and be electrically coupled to the information handling system 100 to provide this power and coupled to bus 108 to provide or receive data or instructions. The PMU 150 may regulate power from a power source such as a battery 152 or A/C power adapter 154. In an embodiment, the battery 152 may be charged via the A/C power adapter 154 and provide power to the components of the information handling system 100 when A/C power from the A/C power adapter 154 is removed.

FIG. 1 further indicates that the information handling system 100 includes an operating system (OS) 160, a basic input/output system (BIOS) firmware/software 162, one or more application programs, or a combination thereof that may be part of the computer executable code 118 that is executed at the CPU 104, the GPU 106, the NPU 108, or a combination thereof, and stored the main memory 110, the static memory 112, the computer readable medium 116 of the drive unit 114, or any combination thereof. The BIOS firmware/software 162 functions to initialize information handling system 100 on power up, to launch the OS 160, and to manage input and output interactions between the OS 160 and the other elements of information handling system 100. In a particular embodiment, BIOS firmware/software 162 resides in the main memory 108 or the static memory 112, and includes machine-executable code that is executed by the CPU 104 to perform various functions of information handling system 100 as described herein. In another embodiment (not illustrated), application programs and BIOS firmware/software 162 can reside in another storage medium of information handling system 100. For example, application programs and BIOS firmware/software 162 can reside in the drive unit 114, in a ROM (not illustrated) associated with information handling system 100, in an option-ROM (not illustrated) associated with various devices of information handling system 100, in a storage system (not illustrated) associated with network channel of the wireless interface adapter 130, in another storage medium of information handling system 100, or a combination thereof. It is to be understood that computer executable code 118 for application programs and BIOS firmware/software 138 can each be implemented as single programs, or as separate programs carrying out the various features as described herein.

As stated above, the information handling system 100 may connect to the external wireless network 132. In particular, the wireless network 132 may have a wireless mesh architecture in accordance with mesh networks described by the wireless data communications standards or similar standards in some embodiments but not necessarily in all embodiments. The wireless interface adapter 130 may connect to the external wireless network 133 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 116 that includes computer executable code 118 (e.g., instructions, parameters, and profiles), or receives and executes computer executable code 118 (e.g., instructions, parameters, and profiles) responsive to a propagated signal; so that a device connected to the wireless network 132 can communicate voice, video or data over the wireless network 132. Further, the computer executable code 118 may be transmitted or received over the wireless network 132 via the network interface device, i.e., the wireless interface adapter 130.

The wireless interface adapter 130 represents a network interface card (NIC) disposed within information handling system 100, on a main circuit board of the information handling system 100, integrated onto another component such as the CPU 104, in another suitable location, or a combination thereof. The wireless interface adapter 130 can include another information handling system, a data storage system, another network, a grid management system, another suitable resource, or a combination thereof. In an embodiment, the wireless interface adapter 130 may operably connect to the network 132. The connection to network 132 may be wired or wireless.

The network interface device shown as wireless interface adapter 130 can provide connectivity to the network 132, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 130 may include an adaptive massive MIMO Multiplexer with transmitter/receiver circuitry, wireless controller circuitry, amplifiers and other circuitry for wireless communications. The wireless interface adapter 130 may also include antenna systems 136 as described above which may be tunable antenna systems for use with the system and methods disclosed in the embodiments herein. The antenna controller 140 may also include wireless controllers to manage authentication, connectivity, communications, power levels for transmission, buffering, error correction, baseband processing, and other functions of the wireless interface adapter 130.

The information handling system 100 can include a set of computer executable code 118 that can be executed to cause the information handling system 100 to perform any one or more of the methods or computer-based functions disclosed herein. For example, computer executable code 118 may execute an email algorithm, various software applications, software agents, or other aspects or components. Various software modules comprising application computer executable code 118 may be coordinated by the OS 160, and/or via an application programming interface (API). An example operating system may include Windows ®, Android ®, and other OS types known in the art. Example APIs may include Win 32, Core Java API, or Android APIs.

The drive unit 114 may include a computer-readable medium 116 in which one or more sets of computer executable code 118 such as software can be embedded to be executed by the CPU 104, the GPU 106, the NPU 108, or a combination thereof, to perform the processes described herein. Similarly, main memory 104 and static memory 106 may also contain a computer-readable medium for storage of one or more sets computer executable code 118 (e.g., instructions, parameters, or profiles) including an email program. The drive unit 114 or static memory 112 also contain space for data storage. Further, the computer executable code 118 may embody one or more of the methods or logic as described herein. In a particular embodiment, the computer executable code 118 may reside completely, or at least partially, within the main memory 104, the static memory 106, and/or within the disk drive 116 during execution by the CPU 104 of the information handling system 100. The CPU 104, the GPU 106, and the NPU 108 also may include computer-readable media.

The main memory 108, the static memory 112, or other memory of the embodiments described herein may contain computer-readable medium (not shown), such as RAM. An example of main memory 108 can include random access memory (RAM) such as static RAM (SRAM), dynamic RAM (DRAM), non-volatile RAM (NV-RAM), or the like, read only memory (ROM), another type of memory, or a combination thereof. The static memory 112 may contain computer-readable medium (not shown), such as NOR or NAND flash memory in some example embodiments. The drive unit 114 may include access to a computer-readable medium 116 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

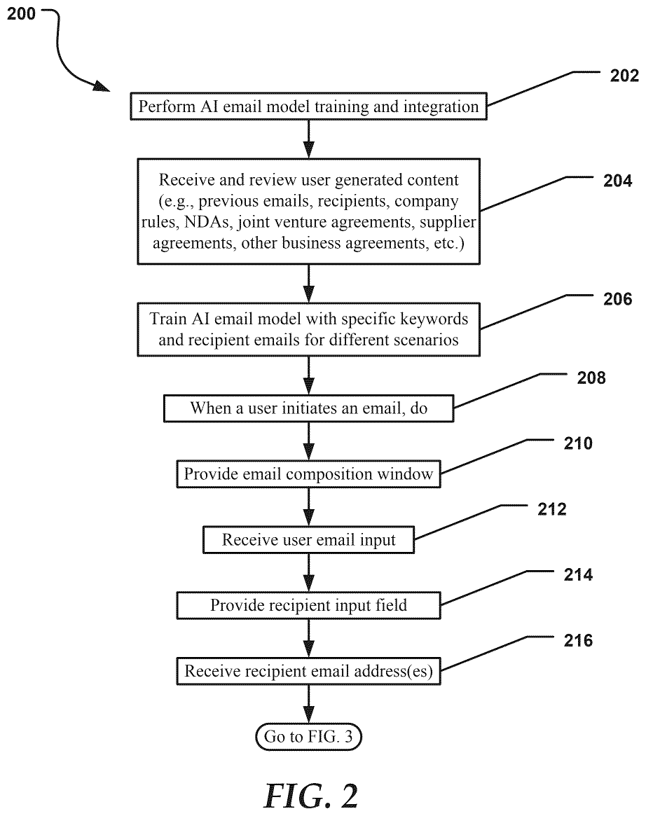

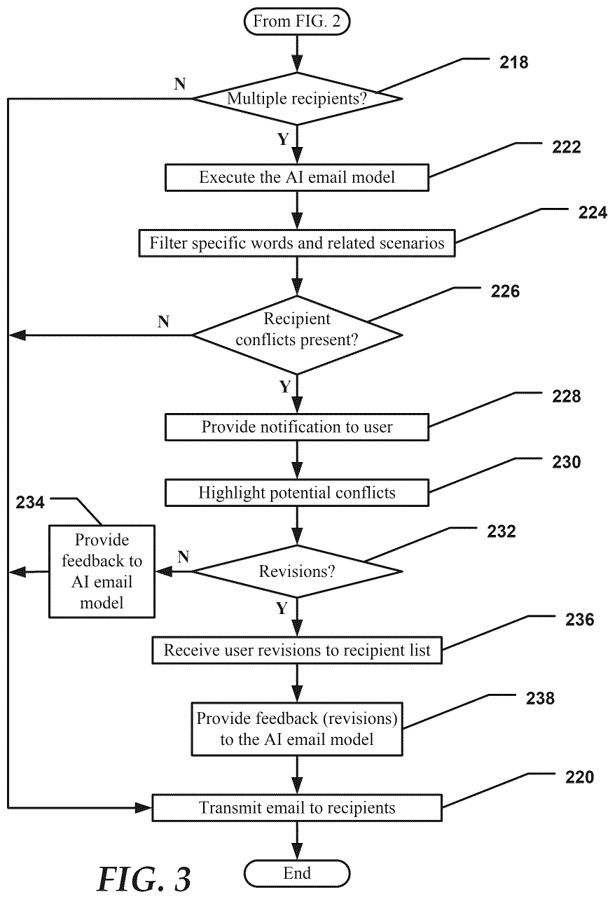

FIGS. 2 and 3 illustrate a flow diagram of a method 200 for securing sensitive information during email communication using artificial intelligence in an information handling system, e.g., the information handling system, according to at least one embodiment of the present disclosure, starting at block 202. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 2 may be executed, or employed in whole, or in part, by the CPU 104, the GPU 106, or the NPU 108 of FIG. 1, a combination thereof, or any other type of controller, device, module, processor, or any combination thereof, operable to employ, or otherwise execute, all, or portions of, the method 200 of FIG. 2. In a particular embodiment, the method steps depicted in FIG. 2 are performed by the NPU 108.

Beginning at block 202, the method 200 includes performing artificial intelligence (AI) email model training and integration. This training and integration may include receiving and reviewing user content (e.g., previous emails, recipients, company rules, non-disclosure agreements (NDAs), other business agreements, etc.) as shown in block 204. Further, at block 206, the training may include training the AI email model with specific keywords and recipient emails for different scenarios to prevent emails from being sent to incorrect recipients. This may prevent recipients who are not intended to be privy to internal company emails from receiving such emails. This may also prevent recipients show are not intended to be privy to certain email content due to NDAs or other business agreements.

At block 208, the method 200 includes entering a do loop and performing the following steps when a user initiates an email. At block 210, the method 200 includes providing an email composition window. Further, at block 212, the method 200 includes receiving user email input, e.g., the user types an email message into the email composition window. Moving to block 214, the method 200 includes providing a recipient input field in which a user may input one or more recipient email addresses. At block 216, the method 200 includes receiving one or more recipient email address(es). The method 200 then proceeds to decision step 218 of FIG. 3.

At decision step 218, the method 200 includes determining whether multiple recipients and therefore, multiple recipient email addresses are included in the recipient input field. If not, the method 200 may proceed directly to block 220 where the method 200 includes transmitting the email to the recipient. Thereafter, the method 200 ends. Conversely, at decision step 218, if there are multiple recipients, the method 200 proceeds to block 222 and includes executing the AI email model. Executing the AI email model may include filtering specific words from the email recipients and recognizing related scenarios based on company rules, NDAs, joint venture agreements, supplier agreements, and other business agreements, as shown in block 224. The specific words may include the recipient's username, the recipient's domain name, or a combination thereof.

Moving to decision step 226, the method 200 includes using the username and/or the domain name, by the AI email model, in determining whether there are any recipient conflicts present based on the based on company rules, NDAs, joint venture agreements, supplier agreements, and other business agreements. These conflicts may be due to one or more NDAs preventing particular usernames from receiving certain emails or preventing anyone at a particular domain name from receiving certain emails. These conflicts may be due to company rules preventing domain names outside of the company domain name from receiving internal emails. These conflicts may be due to competing interests, e.g., competing suppliers intending to conduct business with the company. Of course, exceptions may be made for particular usernames at particular restricted domain names, and particular domain names entirely, in the case of joint business ventures and other prescribed joint business situations.

At decision 226, if the method 200, or the AI email model executing the method 200, determines that there are no conflicts present in the list of email recipients, the method 200 may proceed directly to block 220 and the method 200 includes transmitting the email to the recipients as originally entered by the user. Then, the method 200 may end. On the other hand, at decision step 226, if there are conflicts present, the method 200 may move to block 228 where the method 200 includes providing a conflict notification to the user. At block 230, the method 200 includes highlighting potential conflicts. This may be performed by turning the font for potential conflicted email address a particular color, such as red.

Moving to decision 232, the method 200 includes determining whether user revisions are made. If no user revisions are made, the method 200 may move to block 234 and the method 200 may include providing feedback to the AI email model. This feedback may be used by the AI email model to further train the AI email model, e.g., that a potential conflict that was flagged by the AI email model was, in fact, not an actual conflict. The method 200 may proceed to block 220 and the email may be sent to the recipients list without modification. Thereafter, the method 200 may end.

Returning to decision 232, if user revisions are made, the method 200 may move to block 236 and the method 200 may include receiving one or more user revisions to recipient list. Thereafter, at block 238, the method 200 may include providing feedback to the AI email model that includes the revisions made by the user. This feedback may be used by the AI email model to further train the AI email model. The method 200 may then proceed to block 220 and the method 200 may include transmitting the email to the revised list of recipients. The method 200 may then end.

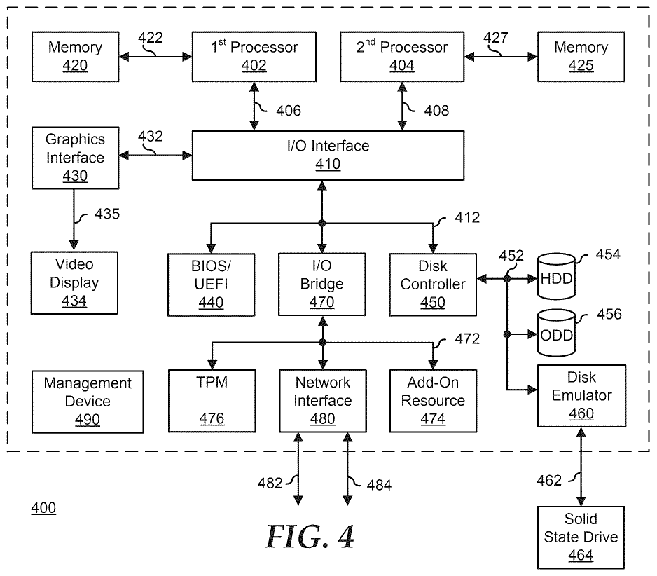

FIG. 4 shows a generalized embodiment of an information handling system 400 according to an embodiment of the present disclosure. Information handling system 400 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described herein. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:
a computer readable medium including an artificial intelligence (AI) electronic mail (email) model; and
a processor operably coupled to the computer readable medium to access the AI email model to:
receive user generated content;
train the AI email model using the user generated content; and
execute the AI email model prior to transmitting an email.

2. The information handling system of claim 1, wherein the user generated content includes previous emails, recipients, company rules, non-disclosure agreements, joint venture agreements, supplier agreements, other business agreements, or a combination thereof.

3. The information handling system of claim 2, wherein the processor further accesses the AI email model to:
execute the AI email model when an email with a list of email recipients is created by a user.

4. The information handling system of claim 3, wherein the processor further accesses the AI email model to:
determine whether any conflicts are present in the list of email recipients.

5. The information handling system of claim 4, wherein the processor further accesses the AI email model to:
transmit the email to the list of email recipients without modification.

6. The information handling system of claim 4, wherein the processor further accesses the AI email model to:
provide notification to the user that a potential conflict exists in the list of email recipients.

7. The information handling system of claim 6, wherein the processor further accesses the AI email model to:
provide notification to the user that a potential conflict exists in the list of email recipients.

8. The information handling system of claim 7, wherein the processor further accesses the AI email model to:
receiving user revisions to the list of email recipients.

9. The information handling system of claim 8, wherein the processor further accesses the AI email model to:
provide feedback to the AI email model with the user revisions to the list of email recipients.

10. The information handling system of claim 9, wherein the processor further accesses the AI email model to:
transmit the email to a revised list of email recipients.

11. A method of transmitting emails at an information handling system using an artificial intelligence (AI) electronic mail (email) model, the method comprising:
receiving user generated content including previous emails, recipients, company rules, non-disclosure agreements, joint venture agreements, supplier agreements, other business agreements, or a combination thereof;
training the AI email model using the user generated content; and
executing the AI email model when an email with a list of email recipients is created prior to transmitting the email.

12. The method of claim 11, further comprising:
determining whether any conflicts are present in the list of email recipients.

13. The method of claim 12, further comprising:
transmitting the email to the list of email recipients without modification when no conflicts are present.

14. The method of claim 11, further comprising:
providing notification to a user that a potential conflict exists in the list of email recipients.

15. The method of claim 11, further comprising:
receiving user revisions to the list of email recipients;
providing feedback to the AI email model with the user revisions to the list of email recipients; and
transmitting the email to a revised list of email recipients.

16. An information handling system, comprising:
a computer readable medium including an artificial intelligence (AI) electronic mail (email) model; and
a processor operably coupled to the computer readable medium to access the AI email model to:
receive user generated content including previous emails, recipients, company rules, non-disclosure agreements, joint venture agreements, supplier agreements, other business agreements, or a combination thereof;
train the AI email model using the user generated content; and
execute the AI email model when an email with a list of email recipients is created prior to transmitting the email.

17. The information handling system of claim 16, wherein the processor further accesses the AI email model to:
determine whether any conflicts are present in the list of email recipients.

18. The information handling system of claim 17, wherein the processor further accesses the AI email model to:
transmit the email to the list of email recipients without modification when no conflicts are present.

19. The information handling system of claim 17, wherein the processor further accesses the AI email model to:
provide notification to a user that a potential conflict exists in the list of email recipients.

20. The information handling system of claim 19, wherein the processor further accesses the AI email model to:
receive user revisions to the list of email recipients;
provide feedback to the AI email model with the user revisions to the list of email recipients. and
transmit the email to a revised list of email recipients.
